(19) United States
(12) Patent Application Publication
(10) Pub. No.: US 2023/0383449 A1
(43) Pub. Date: Nov. 30, 2023

(54) NON-WOVEN FIBROUS TEXTURE WITH CRIMP

(71) Applicant: SAFRAN CERAMICS, LE HAILLAN (FR)

(72) Inventor: Aline PLANCKEEL, MOISSY-CRAMAYEL (FR)

(21) Appl. No.: 18/248,642

(22) PCT Filed: Oct. 11, 2021
(86) PCT No.: PCT/FR2021/051762

§ 371 Date: Apr. 11, 2023

(30) Foreign Application Priority Data
Oct. 12, 2020 (FR) 2010396

(51) Int. Cl. D04H 13/00; B28B 1/30; B28B 1/54

(52) U.S. Cl. CPC D04H 13/00; B28B 1/30; B28B 1/54; D10B 2101/08

(57) ABSTRACT

A fibrous texture includes a stack of at least first, second, third and fourth unidirectional plies. The first, second, third and fourth plies each respectively include a first plurality of rovings aligned in a first direction, a second plurality of rovings aligned in a second direction different from the first direction, a third plurality of rovings aligned in a third direction different from the second direction and a fourth plurality of rovings aligned in a fourth direction different from the third direction. The rovings of the first plurality of rovings being spaced apart from each other by a given distance in a direction perpendicular to the first direction. The rovings of the second plurality of rovings are spaced apart from each other by a given distance in a direction perpendicular to the second direction.

### TECHNICAL FIELD

The present invention relates to the manufacture of composite material parts obtained by injecting a liquid phase, filled or not, into a fibrous reinforcement.

### PRIOR ART

The invention relates in particular to the manufacture of composite materials called “thermostructural” composite materials, namely materials having good mechanical properties and the ability to retain these properties at high temperature, such as carbon/carbon (C/C) composite materials formed from a carbon fiber reinforcement densified by a carbon matrix, ceramic matrix composite materials (CMC) formed of a refractory fiber reinforcement (carbon or ceramic) densified by an at least partially ceramic matrix and composite materials of the oxide/oxide type formed from a reinforcement of oxide fibers (alumina) densified by an at least partially oxide matrix. The invention also relates to the manufacture of composite materials with an organic matrix (CMO), that is to say including a fibrous reinforcement densified by a matrix of organic nature.

A usual method for obtaining parts made of composite material is the liquid method. The liquid method consists in producing a fibrous preform having substantially the shape of a part to be produced, and intended to constitute the reinforcement of the composite material, and in impregnating this preform with a liquid composition containing a precursor of the material of the matrix. The precursor usually comes in the form of a polymer, such as a resin, optionally diluted in a solvent or of a filler suspended in a slip. The transformation of the precursor into a matrix is carried out by heat treatment (polymerization, sintering, etc.). Several successive impregnation cycles can be carried out to achieve the desired degree of densification.

Regarding C/C materials, the carbon fiber reinforcement can be impregnated with liquid carbon precursors such as resins with a relatively high coke content, such as phenolic resins. Regarding composite materials with an organic matrix (CMO), a thermoplastic or thermosetting resin is used to impregnate the fibrous preform.

Regarding CMC or oxide/oxide materials, the parts are generally developed with filtered injection technology of aqueous suspensions filled with ceramic or oxide particles.

For injection, the fibrous reinforcement consists of a fibrous texture obtained by two-dimensional (2D) or three-dimensional (3D) weaving, braiding, placement of fibers, filament winding, lapping, needling.

In the case of a 2D or 3D woven fibrous texture, the latter has a network of channels formed in particular due to the presence of a crimp. These channels allow the liquid composition (filled or not) matrix precursor to circulate throughout the texture.

However, in the case of a fibrous texture formed of unidirectional plies generally obtained by the technique of automatic fiber placement (AFP), there is no circulation channel. This considerably reduces the permeability of the reinforcements to be densified, which complicates, or even prevents, the infiltration of the reinforcement with a liquid composition. In the case of the production of a CMC or oxide/oxide material part, this low permeability can prevent the inter-roving and/or intra-roving diffusion of the ceramic particles.

However, the impregnation of the fibrous preform by a precursor liquid composition of the material of the matrix is an important step in that it then conditions the homogeneity and the level of matrix present in the resulting material and, consequently, the mechanical properties of the material. Indeed, the level of macroporosity present in the final material directly influences the mechanical properties of the material.

### DISCLOSURE OF THE INVENTION

The main purpose of the present invention is therefore to provide a fibrous texture comprising unidirectional plies which has a suitable permeability for the injection of a liquid composition, filled or not, within the texture.

In accordance with the invention, this object is achieved thanks to a fibrous texture comprising a stack of at least first, second, third and fourth unidirectional plies, characterized in that the first ply comprises a first plurality of rovings aligned in a first direction, the rovings of the first plurality of rovings being spaced apart from each other by a given distance in a direction perpendicular to the first direction, in that the second ply comprises a second plurality of rovings aligned in a second direction different from the first direction, the rovings of the second plurality of rovings being spaced apart from each other by a given distance in a direction perpendicular to the second direction, in that the third ply comprises a third plurality of rovings aligned in a third direction different from the second direction, the rovings of the third plurality of rovings being spaced apart from each other by a given distance in a direction perpendicular to the third direction, the rovings of the third plurality of rovings being positioned at the spaces present between the rovings of the first plurality of rovings of the first ply, and in that the fourth ply comprises a fourth plurality of rovings aligned in a fourth direction different from the third direction, the rovings of the fourth plurality of rovings being spaced apart from each other by a given distance in a direction perpendicular to the fourth direction, the rovings of the fourth plurality of rovings being positioned at the spaces present between the rovings of the second plurality of rovings of the second ply.

As in each unidirectional ply, the rovings are spaced apart from each other by a given distance, the fibrous texture of the invention has a crimp comparable to that present in 2D or 3D woven textures. Thanks to the presence of crimp, the fibrous structure includes channels facilitating the infiltration of a liquid composition within the texture. This allows to ensure homogeneous and complete impregnation of the fibrous texture even though it consists of a stack of unidirectional plies.

The fibrous texture of the invention also has a compaction behavior different from a texture comprising unidirectional plies of the prior art. In fact, under the effect of compaction, the excess length of the rovings is absorbed by internal reorganization of the crimp of the yarns.

Furthermore, the interlacing of the rovings reinforces the ply-to-ply bond, which allows to obtain CMC parts that are more resistant to delamination caused by perforation (acoustic perforation type).

According to a characteristic of the texture of the invention, the given distances along which the rovings respectively of the first, second, third and fourth plurality of rovings are spaced apart from each other are each greater than the size of a roving of said first, second, third and fourth pluralities of rovings.

According to another characteristic of the texture of the invention, the second and fourth directions are perpendicular to the first and third directions. The first and third directions can be parallel to a reference direction of the fibrous texture while the second and fourth directions are perpendicular to the reference direction. The first and third directions can also form an angle of +45° with a reference direction of the fibrous texture while the second and fourth directions form an angle of −45° with the reference direction.

According to another characteristic of the texture of the invention, the first and third directions form an angle α with a reference direction of the fibrous texture while the second and fourth directions form an angle β with the reference direction. The angles α and β can be identical or different.

The invention also relates to a method for manufacturing a fibrous texture comprising at least:
producing a first unidirectional ply by draping a first plurality of rovings aligned in a first direction, the rovings of the first plurality of rovings being spaced apart from each other by a given distance in a direction perpendicular to the first direction,
producing a second unidirectional ply by draping over the first ply a second plurality of rovings aligned in a second direction different from the first direction, the rovings of the second plurality of rovings being spaced apart from each other by a given distance in a direction perpendicular to the second direction,
producing a third unidirectional ply by draping over the second ply of a third plurality of rovings aligned in a third direction different from the second direction, the rovings of the third plurality of rovings being spaced apart from each other by a given distance in a direction perpendicular to the third direction, the rovings of the third plurality of rovings being positioned at the spaces present between the rovings of the first plurality of rovings of the first ply,
producing a fourth unidirectional ply by draping over the third ply of a fourth plurality of rovings aligned in a fourth direction different from the third direction, the rovings of the fourth plurality of rovings being spaced apart from each other by a given distance in a direction perpendicular to the fourth direction, the rovings of the fourth plurality of rovings being positioned at the spaces present between the rovings of the second plurality of rovings of the second ply.

According to a characteristic of the method for manufacturing a fibrous texture of the invention, the given distances along which the rovings respectively of the first, second, third and fourth plurality of rovings are spaced apart from each other are each greater than the size of a roving of said first, second, third and fourth plurality of rovings.

According to another characteristic of the method for manufacturing a fibrous texture of the invention, the second and fourth directions are perpendicular to the first and third directions. The first and third directions can be parallel to a reference direction of the fibrous texture while the second and fourth directions are perpendicular to the reference direction. The first and third directions can also form an angle of +45° with a reference direction of the fibrous texture while the second and fourth directions form an angle of −45° with the reference direction.

According to another characteristic of the method for manufacturing a fibrous texture of the invention, the first and third directions form an angle α with a reference direction of the fibrous texture while the second and fourth directions form an angle β with the reference direction. The angles α and β can be identical or different.

The invention also relates to a method for manufacturing a composite material part comprising the following steps:
forming a fibrous texture from refractory ceramic fibers according to the method for manufacturing a fibrous texture of the invention,
placing the fibrous texture in a mold including in its lower portion a porous material part on which rests a first face of said texture,
closing the mold with a counter-mold or a lid placed opposite a second face of the fibrous texture,
injecting, under pressure, a liquid containing a powder of refractory ceramic particles or of particles of a refractory ceramic precursor into the fibrous texture,
draining through the porous material part the liquid having passed through the fibrous texture and retaining the powder of refractory ceramic particles or of particles of a refractory ceramic precursor inside said texture through said porous material part so as to obtain a fibrous preform filled with refractory ceramic particles or particles of a refractory ceramic precursor, the liquid being evacuated through at least one vent present on the bottom of the mold,
drying the fibrous preform,
demolding the fibrous preform, and
heat treating the refractory ceramic particles or the particles of a refractory ceramic precursor present in the fibrous preform in order to form a refractory ceramic matrix in said preform.

### BRIEF DESCRIPTION OF THE DRAWINGS

FIG. 1 is a schematic perspective view showing the formation of a first unidirectional ply of a fibrous texture in accordance with one embodiment of the invention,

FIG. 2 is a schematic perspective view showing the formation of a second unidirectional ply on the first ply of FIG. 1 in accordance with one embodiment of the invention,

FIG. 3 is a schematic perspective view showing the formation of a third unidirectional ply on the second ply of FIG. 2 in accordance with one embodiment of the invention,

FIG. 4 is a schematic perspective view showing the formation of a fourth unidirectional ply on the third ply of FIG. 3 to obtain a fibrous texture in accordance with one embodiment of the invention,

FIG. 5 is a schematic perspective view showing the formation of a fifth unidirectional ply on the fourth ply of the fibrous texture of FIG. 4 in accordance with another embodiment of the invention,

FIG. 6 is a schematic exploded perspective view of an injection tool used to impregnate the fibrous texture of FIG. 4 in accordance with one embodiment of the invention,

FIG. 7 is a schematic sectional view showing the tool of FIG. 6 closed with a fiber texture positioned therein,

FIG. 8 is a schematic sectional view showing the steps of impregnating a fibrous texture with a slip loaded in the tool of FIG. 7.

### DESCRIPTION OF EMBODIMENTS

The invention applies to the production of fibrous textures comprising unidirectional plies, these textures being intended to be impregnated by injection with a liquid composition, filled or not, for the manufacture of parts made of composite material.

With reference to FIGS. 1 to 4, the production of a fibrous texture in accordance with one embodiment of the invention is described. In FIG. 1, a first unidirectional ply 10 is formed by draping a first plurality of rovings 11 on a support 1 of a draping tool. “Unidirectional ply” means here “unidirectional half-plies” in which the rovings are spaced apart from each other, unlike a unidirectional ply in which all the rovings are juxtaposed against each other.

In the example described here, the production of the fibrous texture is carried out using the automatic fiber placement AFP method. The AFP method consists of juxtaposing several fiber rovings, strands or ribbons using a laying head. Each roving is applied and cut independently of the others, allowing precise placement of each roving under any support geometry. The fibers used to form the rovings to be deposited may in particular be glass, carbon, silicon carbide or oxide fibers, or else a mixture of these fibers.

The rovings 11 are draped (that is to say deposited) so as to be aligned in a first direction D_{A11}. The rovings 11 are spaced apart from each other by a given distance D₁₁ in a direction perpendicular to the first direction D_{A11}, the given distance D₁₁ preferably being greater than the size or width of a single roving 11.

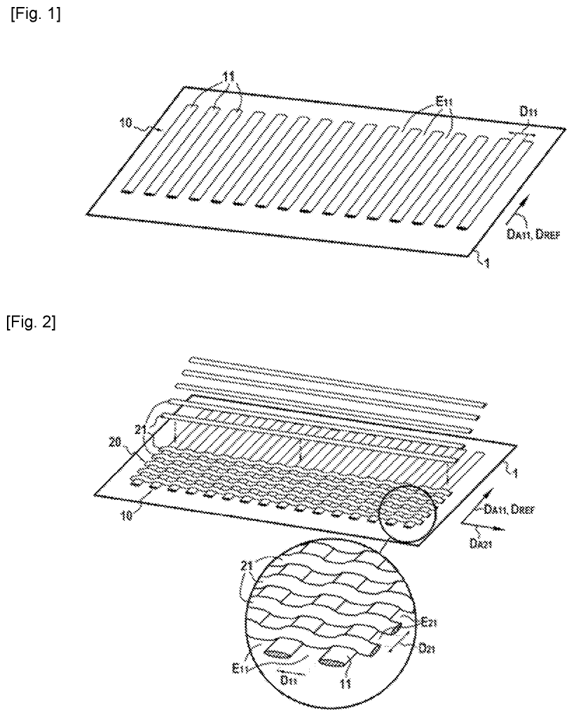

In FIG. 2, a second unidirectional ply 20 is formed by draping a second plurality of rovings 21 over the first unidirectional ply 10. The rovings 21 are draped so as to be aligned in a second direction D_{A21} different from the first alignment direction D_{A11}. In the example described here, the second alignment direction D_{A21} is perpendicular to the first alignment direction D_{A11}. The rovings 21 are spaced apart from each other by a given distance D₂₁ in a direction perpendicular to the second direction D_{A21}, the given distance D₂₁ preferably being greater than the size or width of a single roving 21.

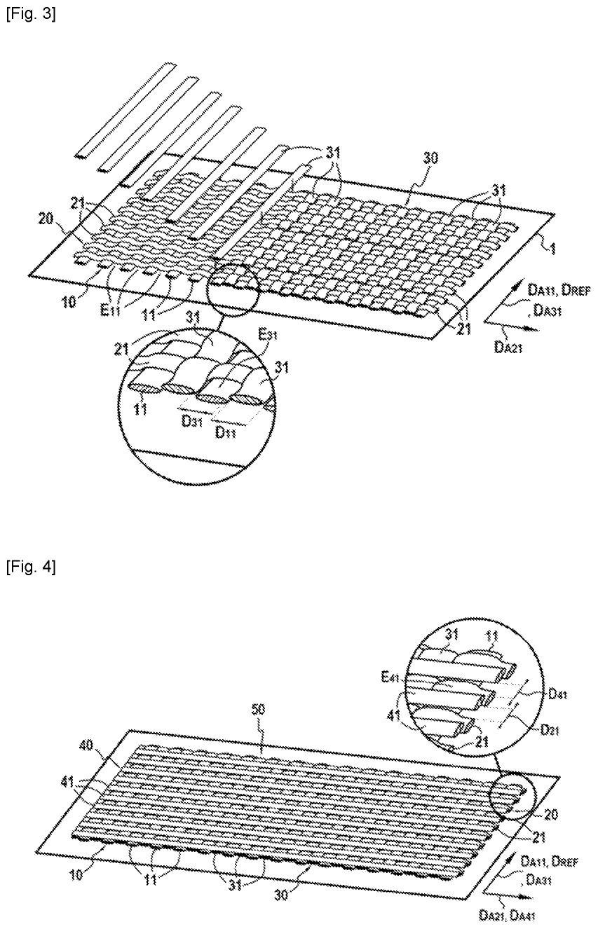

In FIG. 3, a third unidirectional ply 30 is formed by draping a third plurality of rovings 31 over the second unidirectional ply 20. The rovings 31 are draped so as to be aligned in a third direction D_{A31} different from the second alignment direction D_{A21}. In the example described here, the third alignment direction D_{A31} is perpendicular to the second alignment direction D_{A21}. The rovings 31 are spaced apart from each other by a given distance D₃₁ in a direction perpendicular to the third direction D_{A31}, the given distance D₃₁ preferably being greater than the size or width of a single roving 31. The rovings 31 are positioned at the spaces E₁₁ present between the rovings 11 of the first plurality of rovings of the first unidirectional ply 10.

In FIG. 4, a fourth unidirectional ply 40 is formed by draping a fourth plurality of rovings 41 on the third unidirectional ply 30. The rovings 41 are draped so as to be aligned in a fourth direction D_{A41} different from the third alignment direction D_{A31}. In the example described here, the fourth alignment direction D_{A41} is perpendicular to the third alignment direction D_{A31}. The rovings 41 are spaced apart from each other by a given distance D₄₁ in a direction perpendicular to the fourth direction D_{A41}, the given distance D₄₁ preferably being greater than the size or width of a single roving 41. The rovings 41 are positioned at the spaces E₂₁ present between the rovings 21 of the second plurality of rovings of the second unidirectional ply 20.

A non-woven fibrous texture 50 is then obtained comprising a stack of four unidirectional plies 10, 20, 30 and 40. As in each unidirectional ply, the rovings are spaced apart from each other by a given distance, the fibrous texture 50 has a crimp comparable to that present in 2D or 3D woven textures. More precisely, a first crimp is carried out with the rovings 21 of the second unidirectional ply 20 which, when they are deposited on the first unidirectional ply 10, have an undulation due to the spaces E₁₁ present between the rovings 11 of the first ply 10. Similarly, a second crimp is carried out with the rovings 31 of the third unidirectional ply 30 which, when they are deposited on the second unidirectional ply 20, have an undulation due to the spaces E₁₁ and E₂₁ present respectively between the rovings 11 of the first ply 10 and the rovings 21 of the second ply 20. “Crimp” means here the undulation that the threads of a unidirectional ply have when they cross the threads of one or more other underlying unidirectional plies.

Thanks to the presence of crimp, the fibrous structure 50 comprises channels facilitating the infiltration of a liquid composition within the texture. This allows to ensure homogeneous and complete impregnation of the fibrous texture even though it consists of a stack of unidirectional plies.

The spacing distance between the rovings in each unidirectional ply, as here the distances D₁₁, D₂₁, D₃₁ and D₄₁, is defined in particular according to the desired crimp level or angle. The spacing distance is preferably at least equal to the size (diameter, width, section, etc.) of the rovings used in the fibrous texture. In other words, the unidirectional plies of the fibrous texture comprise one out of two rovings compared to a usual unidirectional ply. In the example described here, the spacing distances D₁₁, D₂₁, D₃₁ and D₄₁ are equal to 10.35 mm, the rovings having a size of 6 mm.

The roving direction of a unidirectional ply (ply N) is different from the roving direction of the underlying unidirectional ply (ply N−1). The directions of alignment of the rovings of two adjacent unidirectional plies can be perpendicular to each other or not perpendicular, that is to say that the two directions of alignment form therebetween an angle different from 90°.

In the example described here, the alignment directions D_{A11} and D_{A31} of the first and third unidirectional plies 10 and 30 (plies N and N+2) are parallel to a reference direction D_{REF} while the alignment directions D_{A21} and D_{A41} of the second and third unidirectional plies 20 and 40 (plies N+1 and N+3) are perpendicular to the reference direction D_{REF}. In other words, the fibrous texture 50 is a draping of four unidirectional 0°/90°/0°/90° plies.

According to a variant embodiment, the fibrous texture may comprise a stack of unidirectional plies in which the directions of alignment of the rovings of plies N and N+2 are perpendicular with the directions of alignment of the rovings of plies N+1 and N+3, the directions of alignment of the rovings of plies N and N+2 forming an angle of +45° with a reference direction while the directions of alignment of the rovings of plies N+1 and N+3 form an angle of −45° with the reference direction or vice versa. In other words, in this case, the fibrous texture is a draping of at least four unidirectional plies in +45°/−45°/+45°/−45° or −45°/+45°/−45°/+45°.

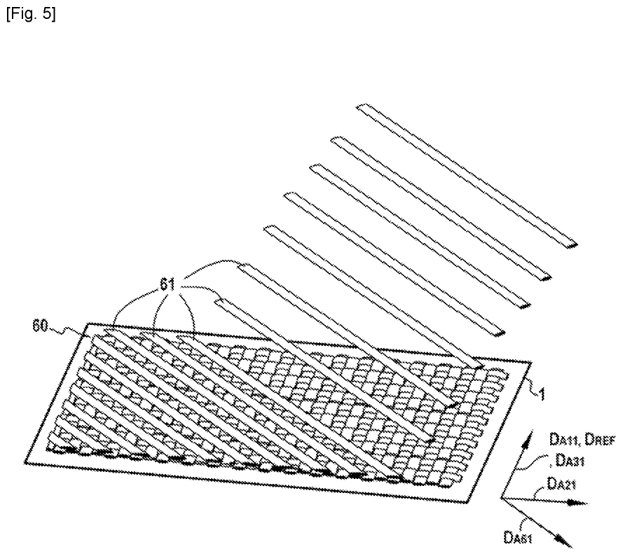

FIG. 5 illustrates the formation of a fifth unidirectional ply 60 on the fibrous fabric 50 formed by draping a fifth plurality of rovings 61 over the fourth unidirectional ply 40. The rovings 61 are draped so as to be aligned in a second direction D_{A61} different from the fourth alignment direction D_{A41}. In the example described here, the fifth alignment direction D_{A61} forms an angle of −45° with the reference direction D_{REF}. The rovings 61 are spaced apart from each other by a given distance d61 in a direction perpendicular to the second direction D_{A61}. In this case, a fibrous texture is obtained consisting of a draping of five unidirectional plies at 0°/90°/0°/90°/−45°. It can be seen in this example that the fibrous structure can comprise one or more unidirectional plies, the direction of alignment of the rovings of which has a variable angle with respect to the reference direction.

In general, the alignment directions D_{A11} and D_{A31} of the first and third unidirectional plies 10 and 30 form an angle α with the reference direction D_{REF} while the alignment directions D_{A21} and D_{A41} of the second and third unidirectional plies 20 and 40 form an angle β with the reference direction D_{REF}. The angles α and β can be identical or different. The angle α or β can be zero so that the alignment directions D_{A11} and D_{A31} or the alignment directions D_{A21} and D_{A41} are parallel to the reference direction D_{REF}.

By way of non-limiting examples, the fibrous texture according to the invention comprises four or more unidirectional plies, the rovings of which are oriented according to the following configurations:
four or more unidirectional plies in 0°/90°/0°/90°/etc. (or 90°/0°/90°/0°/etc.),
four or more unidirectional plies in +45°/−45°/+45°/−45°/etc. (or −45°/+45°/−45°/+45/etc.),
four or more unidirectional plies in +30°/−30°/+30°/−30°/etc. (or −30°/+30°/−30°/+30°/etc.);
four or more unidirectional plies in 0°/−30°/0°/−30°/etc. (or 0°/+30°/0°/+30°/etc.)
four or more unidirectional plies in 90°/−30°/90°/−30°/etc. (or 90°/+30°/90°/+30°/etc.)
four or more unidirectional plies in 0°/+45°/0°/+45°/etc. (or 0°/−45°/0°/−45°/etc.)
16 unidirectional plies in 0°/90°/0°/90°/−45°/+45°/−45°/+45°/−45°/+45°/−45°/+45°/90°/0°/90°/0°.
12 unidirectional plies in 0°/−30°/0°/−30°/90°/−30°/90°/−30°/0°/45°/0°/45°;
etc.

The rovings used to produce the fibrous texture according to the invention are preferably coated with a fugitive binder, for example a tackifying material capable of being eliminated by rinsing with water.

The manufacture of a ceramic matrix composite (CMC) material part from the fibrous texture 50 illustrated in FIG. 4 will now be described. In the example described, the fibrous texture 50 is produced with alumina oxide rovings.

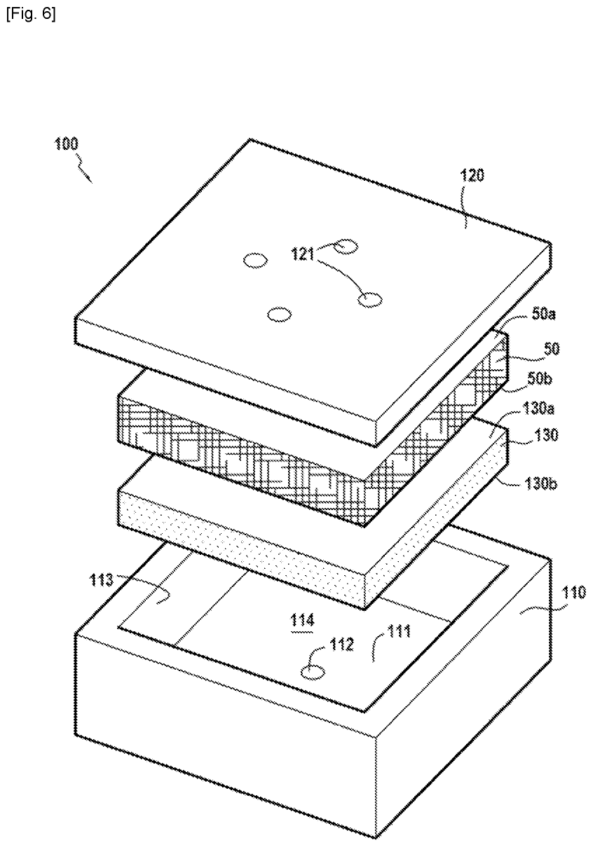

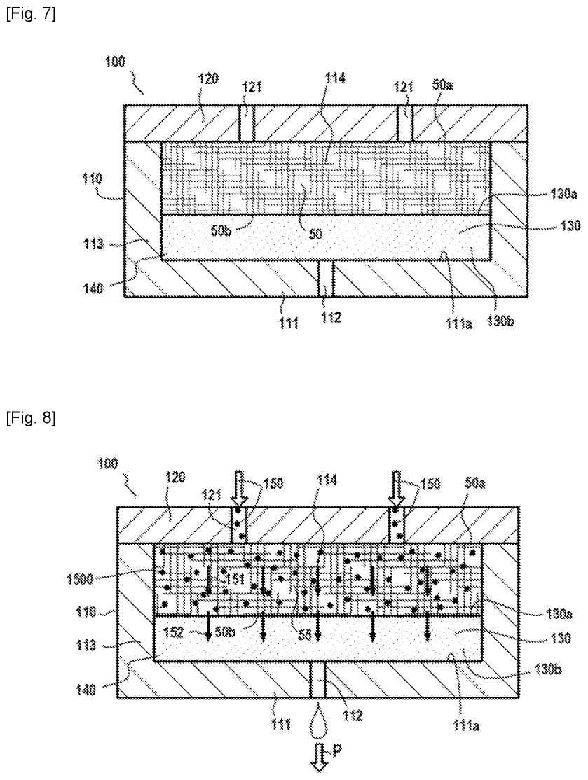

As illustrated in FIGS. 6 and 7, a fibrous texture 50 is placed in a tool 100 which comprises a mold 110 and a counter-mold 120. The mold 110 comprises a bottom 111 provided with a vent 112. The mold 110 also comprises a side wall 113 which forms with the bottom 111 a molding cavity 114. In the example illustrated, the tool 100 in which the fiber texture 50 is present is closed in its lower part by the mold 110 and is closed in its upper part by the counter-mold 120 forming a lid closing the tool 100. The mold 110 and the counter-mold 120 are used to size the preform and therefore the part to be obtained as well as to adjust the fiber level in the part to be obtained.

The counter-mold 120 includes a plurality of injection ports 121 through which a liquid filled with refractory ceramic particles or particles of a refractory ceramic precursor is intended to be injected in order to penetrate into the porosity of the fibrous texture 50 through the first face 50a of the fibrous texture 1. In the example illustrated in FIGS. 6 and 7, the filled liquid is intended to be injected through a plurality of injection ports 121 opening out into different zones of the mold cavity. The mold 110 includes, in turn, a liquid evacuation vent 112.

A porous material part 130 is present in the molding cavity 114 between the mold 110 and the fibrous texture 50. The porous material part 130 has an upper face 130a in contact with the second face 10b of the fibrous texture 50 through which the drainage of the liquid is intended to be carried out. The second face 50b of the fibrous texture 50 is, in the example illustrated in FIGS. 6 and 7, located on the side opposite the first face 50a through which the slip is intended to penetrate into the texture 50. The liquid filled with refractory ceramic particles can also be injected into the sides of the preform.

The porous material part 130 can for example be made of microporous polytetrafluoroethylene (PTFE) such as the “microporous PTFE” products sold by the company Porex®. To produce the porous material part 130, use can for example be made of the material PM 0130 marketed by the company Porex® having a pore size comprised between 1 μm and 2 μm.

The porous material part 130 allows the drainage of the liquid outside the fibrous fabric 50 and its evacuation through the outlet vent 112 due to the application of a pressure gradient between the outlet vent 112 and injection ports 121.

By way of example, the porous material part 130 may have a thickness greater than or equal to 1 mm, or even several millimeters. The average degree of porosity of the porous material part 130 can be around 30%. The average pore size (D50) of the porous material part can for example be comprised between 1 μm and 2 μm.

In an exemplary embodiment, the porous material part 130 may be rigid and have a shape corresponding to the shape of the preform and of the composite material part to be obtained. In this case, the porous material part can for example be produced by thermoforming. Alternatively, the porous material part can be deformable and can take the shape of the mold which corresponds to the shape of the preform and of the composite material part to be obtained.

Before the injection of a slip into the fibrous texture 50, a compaction pressure allowing to compact the fibrous texture 50 between the mold 110 and the counter-mold 120 can be applied by tightening the mold or by means of a press, this compaction pressure being able to be maintained during the injection.

Alternatively, the compaction pressure can be applied after the start of the injection of the filled liquid and can then be maintained. Applying compaction pressure can compact the texture in order to help in liquid drainage and achieve a target thickness for the fibrous preform without damaging the fibrous preform.

In the example described here, the filled liquid corresponds to a slip containing refractory ceramic particles. FIG. 8 illustrates the configuration obtained during the injection of a slip 150 and the drainage of the liquid medium therefrom. The slip 150 was injected under pressure through the injection ports 121 so as to penetrate into the fibrous texture 50 through its first face 50a. The refractory ceramic particles 1500 present in the slip 150 are intended to allow the formation of a refractory ceramic matrix in the porosity of the fibrous texture 50.

The slip can for example be a suspension of a SiC powder in water. The average particle size (D50) of the alumina powder can be comprised between 0.1 μm and 0.3 μm. The alumina powder used can be an alpha alumina powder marketed by the company Baikowski under the name SM8.

The liquid medium of the slip may, for example, comprise an aqueous phase having an acid pH (that is to say a pH less than 7) and/or an alcohol phase comprising for example ethanol. The slip may comprise an acidifier such as nitric acid and the pH of the liquid medium may for example be comprised between 1.5 and 4. The slip may, furthermore, include an organic binder such as polyvinyl alcohol (PVA) which is in particular soluble in water.

As illustrated in FIG. 8, the refractory ceramic particles 1500 are present after injection of the slip 150 into the pores of the fibrous texture 10. The arrows 151 represent the movement of the slip 150 injected into the fibrous texture 10. The arrows 152 represent, in turn, the movement of the medium or liquid phase of the slip drained by the porous material part 130.

The counter-mold 120 exerts pressure on the fibrous texture 10 during and after the injection step.

A pumping P can, moreover, be carried out at the outlet vent 112 during drainage, for example by means of a primary vacuum pump. Carrying out such pumping allows to improve drainage and to dry the fibrous texture more quickly.

As an alternative or in combination, it is possible during the draining to heat the liquid medium still present in the porosity of the fibrous texture in order to evaporate the latter through the second face of the fibrous texture and the porous material part. For example, the temperature of the liquid medium can be raised to a temperature comprised between 80° C. and 105° C.

In this configuration, the porous material part 130 allows to retain in the fibrous texture 50 the refractory ceramic particles 1500 initially present in the slip and that all or part of these particles are deposited by filtration in the fibrous texture 50.

Once the injection and drainage steps have been carried out, a fibrous preform 55 filled with refractory ceramic particles, for example particles of refractory ceramic oxide, for example alumina, is obtained.

The preform obtained is subsequently dried then demolded, the preform being able to retain after demolding the shape adopted in the molding cavity, for example its shape adopted after compaction between the mold and the counter-mold thanks to the presence of a binder in the slip such as PVA.

The preform is then subjected to heat treatment, here sintering, for example in air at a temperature comprised between 1000° C. and 1200° C. in order to sinter the refractory ceramic particles and thus form a refractory ceramic matrix in the porosity of the fibrous preform. It is then possible to obtain a CMC composite material part provided with a fibrous reinforcement formed by the fibrous preform and having a high matrix volume ratio with a homogeneous distribution of the refractory ceramic matrix throughout the fibrous reinforcement.

The filled liquid injected into the preform may, alternatively, include particles of a refractory ceramic precursor, for example of the sol-gel or polymeric type. In this case, the heat treatment includes at least one step of transforming the refractory ceramic precursor into a ceramic material (step called ceramization step) optionally followed by an additional sintering step in order to further densify the composite material part.

In the case of the manufacture of a C/C composite material part, for example a fibrous texture is made of carbon fibers and the latter is impregnated with a liquid carbon precursor such as a phenolic resin. In the case of a composite material part with an organic matrix (CMO), a fibrous texture is produced for example with carbon or glass fibers and the latter is impregnated with an epoxy resin.

1. A fibrous texture comprising a stack of at least first, second, third and fourth unidirectional plies, wherein the first unidirectional ply comprises a first plurality of rovings aligned in a first direction, the rovings of the first plurality of rovings being spaced apart from each other by a given distance in a direction perpendicular to the first direction, wherein the second unidirectional ply comprises a second plurality of rovings aligned in a second direction different from the first direction, the rovings of the second plurality of rovings being spaced apart from each other by a given distance in a direction perpendicular to the second direction, wherein the third unidirectional ply comprises a third plurality of rovings aligned in a third direction different from the second direction, the rovings of the third plurality of rovings being spaced apart from each other by a given distance in a direction perpendicular to the third direction, the rovings of the third plurality of rovings being positioned at the spaces present between the rovings of the first plurality of rovings of the first ply, and wherein the fourth unidirectional ply comprises a fourth plurality of rovings aligned in a fourth direction different from the third direction, the rovings of the fourth plurality of rovings being spaced apart from each other by a given distance in a direction perpendicular to the fourth direction, the rovings of the fourth plurality of rovings being positioned at the spaces present between the rovings of the second plurality of rovings of the second ply.

2. The texture according to claim 1, wherein the given distances along which the rovings respectively of the first, second, third and fourth plurality of rovings are spaced apart from each other are each greater than the size of a roving of said first, second, third and fourth pluralities of rovings.

3. The texture according to claim 1, wherein the second and fourth directions are perpendicular to the first and third directions.

4. The texture according to claim 3, wherein the first and third directions are parallel to a reference direction of the fibrous texture while the second and fourth directions are perpendicular to the reference direction.

5. The texture according to claim 3, wherein the first and third directions form an angle of +45° with a reference direction of the fibrous texture while the second and fourth directions form an angle of −45° with the reference direction.

6. The texture according to claim 1, wherein the first and third directions form an angle α with a reference direction of the fibrous texture while the second and fourth directions form an angle β with the reference direction.

7. A method for manufacturing a fibrous texture comprising:
producing a first unidirectional ply by draping a first plurality of rovings aligned in a first direction, the rovings of the first plurality of rovings being spaced apart from each other by a given distance in a direction perpendicular to the first direction,
producing a second unidirectional ply by draping over the first ply a second plurality of rovings aligned in a second direction different from the first direction, the rovings of the second plurality of rovings being spaced apart from each other by a given distance in a direction perpendicular to the second direction,
producing a third unidirectional ply by draping over the second ply a third plurality of rovings aligned in a third direction different from the second direction, the rovings of the third plurality of rovings being spaced apart from each other by a given distance in a direction perpendicular to the third direction, the rovings of the third plurality of rovings being positioned at the spaces present between the rovings of the first plurality of rovings of the first ply,
producing a fourth unidirectional ply by draping over the third ply of a fourth plurality of rovings aligned in a fourth direction different from the third direction, the rovings of the fourth plurality of rovings being spaced apart from each other by a given distance in a direction perpendicular to the fourth direction, the rovings of the fourth plurality of rovings being positioned at the spaces present between the rovings of the second plurality of rovings of the second ply.

8. The method according to claim 7, wherein the given distances along which the rovings respectively of the first, second, third and fourth plurality of rovings are spaced apart from each other are each greater than the size of a roving of said first, second, third and fourth pluralities of rovings.

9. The method according to claim 7, wherein the second and fourth directions are perpendicular to the first and third directions.

10. The method according to claim 9, wherein the first and third directions are parallel to a reference direction of the fibrous texture while the second and fourth directions are perpendicular to the reference direction.

11. The method according to claim 9, wherein the first and third directions form an angle of +45° with a reference direction of the fibrous texture while the second and fourth directions form an angle of −45° with the reference direction.

12. The method according to claim 7, wherein the first and third directions form an angle α with a reference direction of the fibrous texture while the second and fourth directions form an angle β with the reference direction.

13. A method for manufacturing a composite material part comprising:
forming a fibrous texture by the method for manufacturing a fibrous texture according to claim 7 from refractory ceramic fibers,
placing the fibrous texture in a mold including in its lower portion a porous material part on which rests a first face of said texture,
closing the mold with a counter-mold, a lid or a tarpaulin placed opposite a second face of the fibrous texture,
injecting, under pressure, a liquid containing a powder of refractory ceramic particles or of particles of a refractory ceramic precursor into the fibrous texture,
draining through the porous material part the liquid having passed through the fibrous texture and retaining the powder of refractory ceramic particles or of particles of a refractory ceramic precursor inside said texture through said porous material part so as to obtain a fibrous preform filled with refractory ceramic particles or particles of a refractory ceramic precursor, the liquid being evacuated through at least one vent present on the bottom of the mold,
drying the fibrous preform,
demolding the fibrous preform, and
heat treating the refractory ceramic particles or the particles of a refractory ceramic precursor present in the fibrous preform in order to form a refractory ceramic matrix in said preform.
